(19) United States
(12) Patent Application Publication
(10) Pub. No.: US 2017/0356843 A1
(43) Pub. Date: Dec. 14, 2017

(54) METHODS FOR SAMPLE CHARACTERIZATION

(71) Applicant: BOARD OF REGENTS, THE UNIVERSITY OF TEXAS SYSTEM, Austin, TX (US)

(72) Inventors: Andrea Alu, Austin, TX (US); Yang Zhao, Sunnyvale, CA (US)

(73) Assignee: BOARD OF REGENTS, THE UNIVERSITY OF TEXAS SYSTEM, Austin, TX (US)

(21) Appl. No.: 15/520,875

(22) PCT Filed: Oct. 19, 2015
(86) PCT No.: PCT/US2015/056157

§ 371 Date: Apr. 21, 2017

Related U.S. Application Data
(60) Provisional application No. 62/066,570, filed on Oct. 21, 2014.

(51) Int. Cl. G01N 21/19; G01N 21/552

(52) U.S. Cl. CPC G01N 21/19; G01N 21/554

(57) ABSTRACT

Described are methods of determining a property of a sample, examples of sample properties that can be determined and provided using the methods described herein include, for example, the chirality of the analyte, the presence of chiral analyte, the circular dichroism of sample, the concentration of the analyte in the sample, or a combination thereof.

### STATEMENT OF GOVERNMENT SUPPORT

This invention was made with government support under Grant No. N0014-10-1-0942 awarded by the Office of Naval Research, Grant Nos. FA9550-13-1-0204 and FA9550-10-1-0022 awarded by the Air Force Office of Scientific Research, and Grant No. W911NF-11-1-0447 awarded by the Army Research Office. The government has certain rights in the invention.

### BACKGROUND

Many naturally occurring biomolecules, such as nucleotides, sugars, and amino acids, are chiral. Enantiomers, a pair of chiral isomers with opposite handedness, often exhibit similar physical and chemical properties due to their identical functional groups and composition, yet they can show different toxicity since they bind differently to the receptors of various biological organisms. Detecting enantiomers of different chirality in small quantities can play an important role in drug development, for example to eliminate unwanted side effects. In the last twenty years, the market for single-enantiomer drugs has substantially grown, and today over 50% of drugs currently in use are chiral compounds (Erb, S. Pharm Techn. 2006, 30, s14-s18).

To date, molecular chirality is conventionally determined using circular dichroism (CD) measurements. Chiral molecules on their own typically possess a small CD resonance with magnitude in the range of few tens of millidegrees (Kelly, S M et al. Biochim Et Biophys Acta-Proteins and Proteomics. 2005, 1751, 119-139). There are other challenges in conventional CD measurements: they can be time consuming (often taking up to 30 minutes), and they can involve large amounts of analytes (Kelly, S M et al. Biochim Et Biophys Acta-Proteins and Proteomics. 2005, 1751, 119-139). These measurements can be carried out during and after each synthetic step of a chiral drug synthesis, becoming particularly challenging at the early stages of developing a synthetic approach, when large amounts of analytes are hard to realize due to limited production efficiency. Therefore, being able to detect the handedness of enantiomers with lower concentrations and in shorter time scales could be useful for pharmaceutical applications. The methods disclosed herein address these and other needs.

### SUMMARY

In accordance with the purposes of the disclosed methods, as embodied and broadly described herein, the disclosed subject matter relates to methods of determining a property of a sample. More specifically, provided herein are methods of determining a property of a sample, the method comprising: contacting a device with a sample, wherein the sample comprises an analyte; applying a circularly polarized electromagnetic signal to the sample, the device, or a combination thereof; capturing an electromagnetic signal from the sample, the device, or a combination thereof; and processing the electromagnetic signal to determine a property of the sample.

In some embodiments, the analyte can comprise a chiral molecule. In some embodiments, the chiral molecule can comprise a biomolecule, a macromolecule, a virus, a drug, or a combination thereof.

In some embodiments, contacting the device with the sample comprises depositing a layer of the sample on the device. In some embodiments, depositing a layer of the sample on the device can comprise adsorbing a layer of the sample on the device. In some embodiments, depositing the layer of the sample on the device comprises spin-coating the layer of the sample on the device. In some embodiments, the sample can be deposited in between the first layer and the second layer of the device.

In some embodiments, the device can be integrated with a microfluidic system and contacting the sample with the device can comprise flowing the sample over the device via the microfluidic system. In some embodiments, the method can comprise collecting sequential microfluidic circular dichroism measurements.

The methods described herein can be used to determine a wide variety of properties of the sample that can provide quantitative and/or qualitative information about the sample and/or the analyte. Examples of sample properties that can be determined and provided using the methods described herein include, for example, the chirality of the analyte, the presence of the chiral analyte, the circular dichroism of the sample, the concentration of the analyte in the sample, or a combination thereof.

In some embodiments, the device can be varied (e.g., the dimensions of the first plasmonic particle and/or the second plasmonic particle; the arrangement and/or orientation of the fist plasmonic particle in the first layer; the arrangement and/or orientation; of the second plasmonic particle in the second layer; the arrangement of the first layer and the second layer; the dimensions of the first layer, the second layer, the third layer, or a combination thereof; the material comprising the first layer, the second layer, the third layer, the first plasmonic particle, the second plasmonic particle, or a combination thereof; etc.) to affect the captured electromagnetic signal from the device at a wavelength or wavelength range of interest (e.g., at one or more wavelengths from 400 nm to 2000 nm).

In some embodiments, the device comprises a first layer comprising a first plasmonic particle having a first longitudinal axis and a first transverse axis and a second layer comprising a second plasmonic particle having a second longitudinal axis and a second transverse axis. The first layer can be located proximate to the second layer, and the second longitudinal axis can be rotated at an angle compared to the first longitudinal axis (or vice versa). In some embodiments, the circularly polarized electromagnetic signal can pass through both the sample and the device before being captured.

In some embodiments, the first plasmonic particle and/or the second plasmonic particle can comprise a plasmonic material. Examples of plasmonic materials include, but are not limited to, plasmonic metals (e.g., gold, silver, copper, aluminum, or a combination thereof), plasmonic semiconductors (e.g., silicon carbide), doped semiconductors (e.g., aluminum-doped zinc oxide), transparent conducting oxides, perovskites, metal nitrides, silicides, germanides, and two-dimensional plasmonic materials (e.g., graphene), and combinations thereof.

In some embodiments, the first plasmonic particle and/or the second plasmonic particle can comprise a rod-like particle, wherein the rod-like particle has a length, a width and a height, wherein the length of the rod-like particle is along the first longitudinal axis and/or the second longitudinal axis, and the width is along the first transverse axis and/or the second transverse axis.

Additional advantages will be set forth in part in the description that follows or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE FIGURES

The accompanying figures, which are incorporated in and constitute a part of this specification, illustrate several aspects described below.

FIG. 1 displays schematic plots of enhanced enantiomer chirality sensing. FIG. 1a illustrates circular polarized light impinging onto assemblies of chiral molecules inducing small circular dichroism in the UV region. FIG. 1b illustrates chiral sensing with achiral plasmonic nanostructures. FIG. 1c illustrates enhanced chiral sensing with twisted plasmonic metamaterials.

FIG. 2 displays measurements and simulations of bare twisted metamaterials to create different chiral responses. FIG. 2a displays experimental transmission measurements of twisted metamaterials with twist angles of 30°, 45°, 60°, 75° and 90° for RCP and LCP excitation (no analyzers are used). The twist angle is defined as the angle between the nanorods unit cells, while keeping the lattice dimensions unchanged. Scanning electron microscope (SEM) images are shown in the insets. FIG. 2b displays the corresponding theoretical calculations of the transmission spectrum of the twisted metamaterials. FIG. 2c displays the extracted circular dichroism from the measured transmission spectra showing large circular dichroism (CD) for metamaterials with twist angle of 45° and 60°. FIG. 2d displays theoretical calculations of the circular dichroism for twisted metamaterials. CD is defined as in Equation (1) in degrees.

FIG. 3 displays chiral enhancement factors. FIG. 3a displays chiral enhancement factors from a +60° metamaterial with both left- and right-handed excitations. FIG. 3b displays chiral enhancement factors as a function of twist angle of the metamaterials extracted at the wavelength of 1000 nm. FIG. 3c displays the maximum chirality (on a log 2 scale) as a function of distance from the metamaterial surface.

FIG. 4 displays CD measurements for metamaterials with ±60° twist angles loaded with right-handed (R) and left-handed (S) enantiomers via a flow-cell. Abbreviations used in the legend: ‘+60°’ denotes the +60° metamaterial, ‘−60°’ denotes the -60° metamaterial, ‘w/rac’ denotes ‘with a racemic mixture (e.g., a 1:1 mixture) of right (R) and left (S) handed enantiomers,’ ‘w/S’ denotes ‘with S enantiomers’, and ‘w/R’ denotes ‘with R enantiomers’. The measurement integration time was 0.1 seconds. FIG. 4a displays experimental measurements of a left-handed enantiomer ((S)-(+)-1,2-Propanediol) on ±60° metamaterials. The dark gray triangles (backround CD sum) indicate the center line of the +60° and −60° metamaterials loaded with the racemic mixture (calculated by summing the two black curves in panel (a) and then dividing by two). FIG. 4b displays experimental measurements of a right-handed enantiomer ((R)-(−)-1,2-Propanediol) on ±60° metamaterials. FIG. 4c displays CD summation to remove the inherent CD from the metamaterials, leaving the results attributed to near-field molecular chirality enhancement. The curves show opposite signs for the R and S enantiomers. The solid curves are the averages of the measurement data points. To obtain a CD sum that reflects the molecule property, the CD sum was subtracted from the metamaterials without molecules to remove artifacts introduced by fabrication imperfections. FIG. 4d displays analytical calculations based on a model for conditions in FIG. 4a. FIG. 4e displays analytical calculations for conditions in FIG. 4b. FIG. 4f displays analytical calculations of CD summation for right-handed and left-handed enantiomers on ±60° metamaterials.

FIG. 5 displays larger chiral molecules with monolayer (deposited via spin-coating) and liquid cell measurements. FIG. 5a displays SEM images of ±60° twisted metamaterials. FIG. 5b displays results for a monolayer of a protein (Concanavalin A with 1 mg/ml concentration) spin-coated on ±60° metamaterials, and the CD summation (‘CD sum’) shows a negative bend. In the legend, “w/P” indicates the metamaterial loaded with the protein and “w/buf” indicates the metamaterial loaded with buffer solution. FIG. 5c displays results for an anticancer drug (Irinotecan hydrochloride at a concentration of 1 mg/ml) measured with the liquid cell setup, and the CD summation shows a positive bend. The “w/w” in the legend refers to metamaterials with water; “w/D” represents with the chiral drug. The angles in all panels represent the twist angles of the metamaterials. To obtain a CD sum that reflects the property of the molecules, the CD sum without the molecules was subtracted to remove the artifacts introduced by fabrication imperfection from both FIG. 5b and FIG. 5c.

### DETAILED DESCRIPTION

The methods described herein may be understood more readily by reference to the following detailed description of specific aspects of the disclosed subject matter and the Examples included therein.

Before the present methods are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

### General Definitions

In this specification and in the claims that follow, reference will be made to a number of terms, which shall be defined to have the following meanings:

Throughout the description and claims of this specification the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “the compound” includes mixtures of two or more such compounds, reference to “an agent” includes mixture of two or more such agents, and the like.

“Optional” or “optionally” means that the subsequently described event or circumstance can or cannot occur, and that the description includes instances where the event or circumstance occurs and instances where it does not.

It is understood that throughout this specification the identifiers “first” and “second” are used solely to aid the reader in distinguishing the various components, features, or steps of the disclosed subject matter. The identifiers “first” and “second” are not intended to imply any particular order, amount, preference, or importance to the components or steps modified by these terms.

Reference will now be made in detail to specific aspects of the disclosed methods, examples of which are illustrated in the accompanying Examples and Figures.

### Methods of Use

Circular dichroism refers to the differential absorption of left and right circularly polarized light and is exhibited in the absorption bands of optically active chiral molecules. As used herein, a chiral molecule is any molecule that has a non-superposable mirror image. The symmetry of a molecule (or any other object) determines whether it is chiral. The two mirror images of a chiral molecule are called enantiomers, or optical isomers. Human hands are perhaps one of the most recognized examples of chirality: the left hand is a non-superposable mirror image of the right hand. Indeed, the tem “chirality” is derived from the Greek word for hand, and pairs of enantiomers are often designated by their “handedness” (e.g., right-handed or left-handed). Enantiomers often exhibit similar physical and chemical properties due to their identical functional groups and composition. However, enantiomers behave different in the presence of other chiral molecules or objects, such as circularly polarized light.

An enantiomer can be named by the direction which it rotates the plane of polarized light. If the enantiomer rotates the light clockwise (as seen by a viewer towards whom the light is traveling), that enantiomer is labeled (+). Its mirror-image is labeled (-) and rotates the light counterclockwise. The handedness of enantiomers can be related to their pharmacological effects, especially their potency and toxicity (Hutt, A J and Tan, S C. Drugs. 1996, 52, 1-12). In the case of chiral drugs, in some examples only one enantiomer produces the desired pharmacological effect, while the other enantiomer can be less active or merely inactive. In some cases, the other enantiomer can produce unwanted side effects.

Circularly polarized light occurs when the direction of the electric field vector rotates about its propagation direction while the vector retains a constant magnitude. At a single point in space, the circularly polarized-vector will trace out a circle over one period of the wave frequency. For left circularly polarized light (LCP), with propagation towards the observer, the electric vector rotates counterclockwise. For right circularly polarized light (RCP), the electric vector rotates clockwise.

When circularly polarized light passes through an absorbing optically active medium, the speeds between right and left polarizations differ, as well as their wavelength, and the extent to which they are absorbed. As circularly polarized light is chiral, it interacts differently with chiral molecules. That is, the two types of circularly polarized light are absorbed to different extents by a chiral molecule. In a circular dichroism experiment, equal amounts of left and right circularly polarized light of a selected wavelength (or range of wavelengths) are alternately radiated into a (chiral) sample. One of the two polarizations is absorbed more than the other one and this wavelength-dependent difference of absorption is measured yielding the circular dichroism spectrum of the sample.

Chiral molecules on their own typically possess a small CD resonance with magnitude in the range of few tens of millidegrees (Kelly, S M et al. Biochim Et Biophys Acta-Proteins and Proteomics. 2005, 1751, 119-139). There are other challenges in conventional CD measurements: they cannot directly detect the handedness of the chiral molecule, they can be time consuming (often taking up to 30 minutes), and they can involve large amounts of analytes.

Provided herein are methods of determining a property of a sample, the method comprising: contacting a device with a sample, wherein the sample comprises an analyte; applying a circularly polarized signal to the sample, the device, or a combination thereof; capturing an electromagnetic signal from the sample, the device, or a combination thereof; and processing the electromagnetic signal to determine a property of the sample. In some examples, the methods described herein comprise circular dichroism measurements.

In some embodiments, contacting the device with the sample comprises depositing a layer of the sample on the device. Depositing a layer of the sample on the device can comprise any method for depositing a solution consistent with the devices and methods described herein, for example, spin-coating, drop casting, adsorbing, or creating a liquid cell that contains the sample on the device. In some embodiments, depositing a layer of the sample on the device comprises spin-coating a layer of the sample on the device. In some embodiments, the sample can be deposited in between the first layer and the second layer of the device.

In some embodiments, the device can be integrated with a microfluidic system and contacting the sample with the device can comprise flowing the sample over the device via the microfluidic system. In some embodiments, the method can comprise collecting sequential microfluidic circular dichroism measurements.

In some embodiments, the layer of the sample has a thickness of 10 nm.

In some embodiments, the layer of the sample comprises a monolayer of the sample.

The methods described herein can be several orders of magnitude more sensitive than conventional circular dichroism methods. In some embodiments, the methods described herein can detect much smaller amounts of analytes than conventional circular dichroism methods. In some embodiments, the sample can comprise 15 micromoles or less of the analyte (e.g., 12 micromoles or less, 1200 nanomoles or less, 120 nanomoles or less, 12 nanomoles or less, 1200 picomoles or less, 120 picomoles or less, 12 picomoles or less, 1200 attomoles or less, 120 attomoles or less, 12 attomoles or less, 1200 zeptomoles or less, or 120 zeptomoles or less). In some embodiments, the sample can comprise 11.8 zeptomoles or more of the analyte (e.g., 120 zeptomoles or more, 1200 zeptomoles or more, 12 attomoles or more, 120 attomoles or more, 1200 attomoles or more, 12 femtomoles or more, 120 femtomoles or more, 1200 femtomoles or more, 12 picomoles or more, 120 picomoles or more, 1200 picomoles or more, 12 nanomoles or more, 120 nanomoles or more, 1200 nanomoles or more, or 12 micromoles or more). The amount of analyte can range from any of the minimum values described above to any of the maximum values described above, for example from 11.8 zeptomoles to 15 micromoles (e.g., from 11.8 zeptomoles to 1200 nanomoles, from 11.8 zeptomoles to 120 nanomoles, from 11.8 zeptomoles to 12 nanomoles, from 11.8 zeptomoles to 1200 picomoles, from 11.8 zeptomoles to 120 picomoles, from 11.8 zeptomoles to 12 picomoles, from 11.8 zeptomoles to 1200 attomoles, from 11.8 zeptomoles to 120 attomoles, from 11.8 zeptomoles to 12 attomoles, from 11.8 zeptomoles to 1200 zeptomoles, or from 11.8 zeptomoles to 120 zeptomoles). In some embodiments, the sample can comprise 11.8 zeptomoles of analyte.

In some embodiments, the analyte can comprise a chiral molecule. In some embodiments, the chiral molecule can comprise a biomolecule, a virus, a drug, or a combination thereof. As used herein, a biomolecule can comprise, for example, a nucleotide, an enzyme, an amino acid, a protein, a polysaccharide, a lipid, a nucleic acid, a vitamin, a hormone, a polypeptide, DNA, or a combination thereof. In other examples the chiral molecule can be a macromolecule, such as a cyclodextrins, calixarenes, cucurbiturils, crown ethers, cyclophanes, cryptands, nanotubes, fullerenes, and dendrimers. In some embodiments, the analyte can comprise Concanavalin A, (S)-(+)-1,2-Propanediol, (R)-(−)-1,2,-Propanediol, irinotecan hydrochloride, or a combination thereof.

In some embodiments, the analyte can comprise a drug. Examples of chiral drugs include, but are not limited to, acebutolol, acenocoumarol, alprenolol, alacepril, albuterol, almeterol, alogliptin, amoxicillin, amphetamine, ampicillin, arformoterol, armodafinil, atamestane, atenolol, atorvastatin, azlocillin, aztreonam, benazepril, benoxaprophen, benzylpenicillin, betaxolol, bupivacaine, calstran, captopril, carvedilol, cefalexin, cefaloglycin, cefamandole, cefapirin, cefazaflur, cefonicid, ceforanide, cefpimizole, cefradine, cefroxadine, ceftezole, cefuroxime, cetirizine, cilazapril, citalopram, cloxacillin, cyclophosphamide, delapril, deprenyl, dexbrompheniramine, dexchlorpheniramine, dexfenfluramine, dexibuprofen, dexketoprofen, dexlansoprazole, dexmedetomidine, dexmethylphenidate, dexpramipexole, dexrazoxane, dextroamphetamine, dextromethorphan, dextrorphan, dicloxacillin, diltiazem, disopyramide, drospirenone, enalapril, epicillin, escitalopram, escitazolam, esketamine, eslicarbazepine acetate, esmirtazapine, esomeprazole, esreboxetine, eszopiclone, ethambutol, ethosuximide, exemestane, felodipine, fenprofen, fimasartan, flecainide, flucloxacillin, fluoxetine, gestonorone, hexobarbitol, ibuprofen, idapril, imipenem, irinotecan hydrochloride, isoflurane, ketoprofen, ketamine, labetalol, lansoprazole, levacetylmethadol, levetiracetam, levoamphetamine, levobetaxolol, levobupivacaine, levalbuterol, levocetirizine, levofenfluramine, levofloxacin, levomethamphetamine, levomethorphan, levomilnacipran, levonorgestrel, levopropylhexedrine, levorphanol, levosalbutamol, levosulpiride, levoverbenone, lisinopril, loratadine, lorazepam, mandipine, mecillinam, mephenytoine, mephobarbital, meropenem, methadone, methamphetamine, methorphan, methylphenidate, metoprolol, mezlocillin, milnacipran, modafinil, moexipril, moxalactam, naproxen, nicardipine, nimodipine, nisoldipine, norpseudoephedrine, ofloxacin, omeprazole, oxacillin, oxazepam, pantoprazole, penbutolol, penicillamine, penicillin, perindopril, pentobarbital,phenoxymethylpenicillin, pindolol, piperacillin, prilocaine, propafenone, propanolol, quinapril, ramipril, rentiapril, salbutamol, secobarbital, selegiline, spirapril, sotalol, temazepam, terfenadine, terbutaline, thalidomide, thiohexital, thiopental, timolol, tocainide, trandolapril, verapamil, varvedilol, warfarine, zofenopril, zopiclone, and combinations thereof.

In some embodiments, the circularly polarized electromagnetic signal can comprise circularly polarized light at one or more wavelength from 400 nm to 2000 nm. In some examples, the circularly polarized electromagnetic signal can comprise right circularly polarized light, left circularly polarized light, or a combination thereof.

In some embodiments, applying the circularly polarized electromagnetic signal to the sample, the device, or a combination thereof; capturing an electromagnetic signal from the sample, the device, or a combination thereof; and processing the electromagnetic signal can comprise performing circular dichroism spectroscopy, and can be performed using standard spectroscopy techniques and instrumentation known in the art. In some examples, the applied circularly polarized light can pass through the sample and the device before being captured and processed.

The methods described herein can be used to determine a wide variety of properties of the sample that can provide quantitative and/or qualitative information about the sample and/or the analyte. Examples of sample properties that can be determined and provided using the methods described herein include, for example, the chirality of the analyte, the presence of a chiral analyte, the circular dichroism of the sample, the concentration of the analyte in the sample, or a combination thereof.

In some embodiments, the device comprises a first layer comprising a first plasmonic particle having a first longitudinal axis and a first transverse axis and a second layer comprising a second plasmonic particle having a second longitudinal axis and a second transverse axis. The first layer can be located proximate to the second layer, and the second longitudinal axis can be rotated at an angle compared to the first longitudinal axis. As used herein, the angle can be in either a clockwise direction or a counterclockwise direction. For example an angle of 30° is meant to include both +30° and −30°, unless specifically denoted otherwise. As used herein, proximate is meant within 2000 nm. In some embodiments, the first layer and the second layer can be substantially parallel. In some embodiments, the device can further comprise an additional layer comprising an additional plasmonic particle having a longitudinal axis and a transverse axis, wherein the additional layer can be located proximate to the first layer and/or the second layer, and the longitudinal axis of the additional plasmonic particle is rotated at an angle compared to the first longitudinal axis and/or the second longitudinal axis.

In some embodiments, the device can be varied (e.g., the dimensions of the first plasmonic particle and/or the second plasmonic particle; the arrangement and/or orientation of the fist plasmonic particle in the first layer; the arrangement and/or orientation; of the second plasmonic particle in the second layer; the arrangement of the first layer and the second layer; the dimensions of the first layer, the second layer, the third layer, or a combination thereof; the material comprising the first layer, the second layer, the third layer, the first plasmonic particle, the second plasmonic particle, or a combination thereof; etc.) to affect the captured electromagnetic signal from the device at a wavelength or wavelength range of interest (e.g., at one or more wavelengths from 400 nm to 2000 nm).

In some embodiments the first layer and/or second layer can further comprise a dielectric material. The dielectric material can be any dielectric material consistent with the methods and compositions disclosed herein, such as, for example, a transparent dielectric material. As used herein, a “transparent dielectric material” is meant to include any dielectric material that is transparent at the wavelength or wavelength region of interest. Examples of dielectric materials include, but are not limited to, glass, quartz, air, nitrogen, sulfur hexafluoride, parylene, mineral oil, silicon dioxide, mica, poly(methyl methacrylate), polyamide, polycarbonate, polyester, polypropylene, polytetrafluoroethylene, hexafluoropropane, octafluorocyclobutane, perfluorobutane, hafnium oxide, hafnium silicate, tantalum pentoxide, zirconium dioxide, zirconium silicate, and combinations thereof. In some embodiments, the dielectric material comprises silicon dioxide. In some embodiments the first layer is 10 nm thick or more (e.g., 15 nm or more, 20 nm or more, 25 nm or more, 30 nm or more, 35 nm or more, 40 nm or more, 45 nm or more, 50 nm or more, 55 nm or more, 60 nm or more, 65 nm or more, 70 nm or more, 75 nm or more, 80 nm or more, 85 nm or more, 90 nm or more, or 95 nm or more). In some embodiments, the first layer is 100 nm thick or less (e.g. 95 nm or less, 90 nm or less, 85 nm or less, 80 nm or less, 75 nm or less, 70 nm or less, 65 nm or less, 60 nm or less, 55 nm or less, 50 nm or less, 45 nm or less, 40 nm or less, 35 nm or less, 30 nm or less, 25 nm or less, 20 nm or less, or 15 nm or less). The thickness of the first layer can range from any of the minimum values described above to any of the maximum values described above, for example from 10 nm to 100 nm (e.g., from 10 nm to 90 nm, from 10 nm to 80 nm, from 10 nm to 70 nm, from 20 nm to 60 nm, from 30 nm to 50 nm, or from 35 nm to 45 nm). In some embodiments, the first layer is 40 nm thick.

In some embodiments, the second layer is 10 nm thick or more (e.g., 15 nm or more, 20 nm or more, 25 nm or more, 30 nm or more, 35 nm or more, 40 nm or more, 45 nm or more, 50 nm or more, 55 nm or more, 60 nm or more, 65 nm or more, 70 nm or more, 75 nm or more, 80 nm or more, 85 nm or more, 90 nm or more, or 95 nm or more). In some embodiments, the second layer is 100 nm thick or less (e.g. 95 nm or less, 90 nm or less, 85 nm or less, 80 nm or less, 75 nm or less, 70 nm or less, 65 nm or less, 60 nm or less, 55 nm or less, 50 nm or less, 45 nm or less, 40 nm or less, 35 nm or less, 30 nm or less, 25 nm or less, 20 nm or less, or 15 nm or less). The thickness of the second layer can range from any of the minimum values described above to any of the maximum values described above, for example from 10 nm to 100 nm (e.g., from 10 nm to 90 nm, from 10 nm to 80 nm, from 10 nm to 70 nm, from 20 nm to 60 nm, from 30 nm to 50 nm, or from 35 nm to 45 nm). In some embodiments, the second layer is 40 nm thick.

In some embodiments, the first layer and second layer can be separated by a distance. In some embodiments, the distance can be 10 nm or more (e.g., 15 nm or more, 20 nm or more, 25 nm or more, 30 nm or more, 35 nm or more, 40 nm or more, 45 nm or more, 50 nm or more, 60 nm or more, 70 nm or more, 80 nm or more, 90 nm or more, 100 nm or more, 125 nm or more, 150 nm or more, 175 nm or more, 200 nm or more, 250 nm or more, 300 nm or more, 350 nm or more, 400 nm or more, 450 nm or more, 500 nm or more, 550 nm or more, 600 nm or more, 650 nm or more, 700 nm or more, or 750 nm or more). In some embodiments, the distance can be 800 nm or less (e.g. 750 nm or less, 700 nm or less, 650 nm or less, 600 nm or less, 550 nm or less, 500 nm or less, 450 nm or less, 400 nm or less, 350 nm or less, 300 nm or less, 250 nm or less, 200 nm or less, 175 nm or less, 150 nm or less, 125 nm or less, 100 nm or less, 90 nm or less, 80 nm or less, 70 nm or less, 60 nm or less, 50 nm or less, 45 nm or less, 40 nm or less, 35 nm or less, 30 nm or less, 25 nm or less, 20 nm or less, or 15 nm or less). The distance between the first layer and the second layer can range from any of the minimum values described above to any of the maximum values described above, for example from 10 nm to 800 nm (e.g., from 10 nm to 700 nm, from 10 nm to 600 nm, from 10 nm to 500 nm, from 10 nm to 400 nm, from 10 nm to 300 nm, from 10 nm to 200 nm, from 10 nm to 150 nm, from 20 nm to 140 nm, from 30 nm to 130 nm, from 40 nm to 120 nm, from 50 nm to 110 nm, from 60 nm to 100 nm, or from 70 nm to 90 nm). In some embodiments, the distance can be 80 nm. In some embodiments, the distance between the first layer and the second layer can comprise a dielectric material. The dielectric material can be any dielectric material consistent with the methods and compositions disclosed herein, such as, for example, a transparent dielectric material. Examples of dielectric materials include, but are not limited to, glass, quartz, air, nitrogen, sulfur hexafluoride, parylene, mineral oil, silicon dioxide, mica, poly(methyl methacrylate), polyamide, polycarbonate, polyester, polypropylene, polytetrafluoroethylene, hexafluoropropane, octafluorocyclobutane, perfluorobutane, hafnium oxide, hafnium silicate, tantalum pentoxide, zirconium dioxide, zirconium silicate, and combinations thereof In some embodiments, the dielectric material comprises silicon dioxide. In some embodiments, the circularly polarized electromagnetic signal passes through both the sample and the device before being captured.

In some embodiments, the device further comprises a third layer with a thickness. In some embodiments, the third layer is located between the first layer and the second layer. In some embodiments, the first layer, the second layer, and the third layer form a sandwich type structure. In some embodiments, the third layer comprises a dielectric material. Examples of dielectric materials include, but are not limited to, glass, quartz, air, nitrogen, sulfur hexafluoride, parylene, mineral oil, silicon dioxide, mica, poly(methyl methacrylate), polyamide, polycarbonate, polyester, polypropylene, polytetrafluoroethylene, hexafluoropropane, octafluorocyclobutane, perfluorobutane, hafnium oxide, hafnium silicate, tantalum pentoxide, zirconium dioxide, zirconium silicate, and combinations thereof In some embodiments, the dielectric material comprises silicon dioxide. In some embodiments, the thickness of the third layer can be 10 nm or more (e.g., 15 nm or more, 20 nm or more, 25 nm or more, 30 nm or more, 35 nm or more, 40 nm or more, 45 nm or more, 50 nm or more, 60 nm or more, 70 nm or more, 80 nm or more, 90 nm or more, 100 nm or more, 125 nm or more, 150 nm or more, 175 nm or more, 200 nm or more, 250 nm or more, 300 nm or more, 350 nm or more, 400 nm or more, 450 nm or more, 500 nm or more, 550 nm or more, 600 nm or more, 650 nm or more, 700 nm or more, or 750 nm or more). In some embodiments, the thickness of the third layer can be 800 nm or less (e.g. 750 nm or less, 700 nm or less, 650 nm or less, 600 nm or less, 550 nm or less, 500 nm or less, 450 nm or less, 400 nm or less, 350 nm or less, 300 nm or less, 250 nm or less, 200 nm or less, 175 nm or less, 150 nm or less, 125 nm or less, 100 nm or less, 90 nm or less, 80 nm or less, 70 nm or less, 60 nm or less, 50 nm or less, 45 nm or less, 40 nm or less, 35 nm or less, 30 nm or less, 25 nm or less, 20 nm or less, or 15 nm or less). The thickness of the third layer can range from any of the minimum values described above to any of the maximum values described above, for example from 10 nm to 800 nm (e.g., from 10 nm to 700 nm, from 10 nm to 600 nm, from 10 nm to 500 nm, from 10 nm to 400 nm, from 10 nm to 300 nm, from 10 nm to 200 nm, from 10 nm to 150 nm, from 20 nm to 140 nm, from 30 nm to 130 nm, from 40 nm to 120 nm, from 50 nm to 110 nm, from 60 nm to 100 nm, or from 70 nm to 90 nm). In some examples, the thickness of the third layer can be 80 nm.

As used herein, “a first plasmonic particle” and “the first plasmonic particle” are meant to include any number of the first plasmonic particle in any arrangement in the first layer. Thus, for example “a first plasmonic particle” includes one or more first plasmonic particles. In some embodiments, the first plasmonic particle can comprise a plurality of the first plasmonic particle. In some embodiments, the first plasmonic particle can comprise a plurality of the first plasmonic particle arranged in an ordered array. In some examples, the ordered array comprising a plurality of the first plasmonic particle can comprise a plurality of the first plasmonic particle arranged in a grid-like array, wherein the separation between the each of the first plasmonic particles in the array (e.g., between one particle and its nearest neighboring particle within the same layer) can be 5 nm or more (e.g., 10 nm or more, 20 nm or more, 30 nm or more, 40 nm or more, 50 nm or more, 60 nm or more, 70 nm or more, 80 nm or more, 90 nm or more, 100 nm or more, 200 nm or more, 300 nm or more, 400 nm or more, 500 nm or more, 600 nm or more, 700 nm or more, 800 nm or more, 900 nm or more, 1 μm or more, 2 μm or more, 3 μm or more, or 4 μm or more). In some examples, the separation between the each of the first plasmonic particles in the array can be 5 μm or less (e.g., 4 μm or less, 3 μm or less, 2 μm or less, 1 μm or less, 900 nm or less, 800 nm or less, 700 nm or less, 600 nm or less, 500 nm or less, 400 nm or less, 300 nm or less, 200 nm or less, 100 nm or less, 90 nm or less, 80 nm or less, 70 nm or less, 60 nm or less, 50 nm or less, 40 nm or less, 30 nm or less, 20 nm or less, or 10 nm or less). The separation between the each of the first plasmonic particles in the array can range from any of the minimum values described above to any of the maximum values described above, for example from 5 nm to 5 μm (e.g., from 5 nm to 4 μm, from 5 nm to 3 μm, from 5 nm to 2 μm, from 5 nm to 1 μm, from 5 nm to 900 nm, from 5 nm to 800 nm, from 5 nm to 700 nm, from 10 nm to 600 nm, from 100 nm to 500 nm, or from 200 nm to 400 nm). In some examples, the separation between the each of the first plasmonic particles in the array is 300 nm.

As used herein, “a second plasmonic particle” and “the second plasmonic particle” are meant to include any number of the second plasmonic particle in any arrangement in the second layer. Thus, for example “a second plasmonic particle” includes one or more second plasmonic particle. In some embodiments, the second plasmonic particle can comprise a plurality of the second plasmonic particle. In some embodiments, the second plasmonic particle can comprise a plurality of the second plasmonic particle arranged in an ordered array. In some examples, the ordered array comprising a plurality of the second plasmonic particle can comprise a plurality of the second plasmonic particle arranged in a grid-like array, wherein the separation between the each of the second plasmonic particles in the array (e.g., between one particle and its nearest neighboring particle within the same layer) can be 5 nm or more (e.g., 10 nm or more, 20 nm or more, 30 nm or more, 40 nm or more, 50 nm or more, 60 nm or more, 70 nm or more, 80 nm or more, 90 nm or more, 100 nm or more, 200 nm or more, 300 nm or more, 400 nm or more, 500 nm or more, 600 nm or more, 700 nm or more, 800 nm or more, 900 nm or more, 1 μm or more, 2 μm or more, 3 μm or more, or 4 μm or more). In some examples, the separation between the each of the second plasmonic particles in the array can be 5 μm or less (e.g., 4 μm or less, 3 μm or less, 2 μm or less, 1 μm or less, 900 nm or less, 800 nm or less, 700 nm or less, 600 nm or less, 500 nm or less, 400 nm or less, 300 nm or less, 200 nm or less, 100 nm or less, 90 nm or less, 80 nm or less, 70 nm or less, 60 nm or less, 50 nm or less, 40 nm or less, 30 nm or less, 20 nm or less, or 10 nm or less). The separation between the each of the second plasmonic particles in the array can range from any of the minimum values described above to any of the maximum values described above, for example from 5 nm to 5 μm (e.g., from 5 nm to 4 μm, from 5 nm to 3 μm, from 5 nm to 2 μm, from 5 nm to 1 μm, from 5 nm to 900 nm, from 5 nm to 800 nm, from 5 nm to 700 nm, from 10 nm to 600 nm, from 100 nm to 500 nm, or from 200 nm to 400 nm). In some examples, the separation between the each of the second plasmonic particles in the array is 300 nm.

In some embodiments, the first plasmonic particle and/or the second plasmonic particle can comprise a plasmonic material. Examples of plasmonic materials include, but are not limited to, plasmonic metals (e.g., gold, silver, copper, aluminum, or a combination thereof), plasmonic semiconductors (e.g., silicon carbide), doped semiconductors (e.g., aluminum-doped zinc oxide), transparent conducting oxides, perovskites, metal nitrides, silicides, germanides, and two-dimensional plasmonic materials (e.g., graphene), and combinations thereof. In some embodiments, the first plasmonic particle and/or the second plasmonic particle can comprise a gold particle.

In some embodiments, the first plasmonic particle can comprise a particle with a shape that is anisotropic within the plane of the first layer (e.g., a rod, a quadrilateral, an ellipse, a triangle, a polygon, etc.). In some embodiments, the second plasmonic particle can comprise a particle with a shape that is anisotropic within the plane of the second layer (e.g., a rod, a quadrilateral, an ellipse, a triangle, a polygon, etc.). In some embodiments, the first plasmonic particle and/or the second plasmonic particle can comprise a rod-like particle, wherein the rod-like particle has a length, a width and a height, wherein the length of the rod-like particle is along the first longitudinal axis and/or the second longitudinal axis, and the width is along the first transverse axis and/or the second transverse axis.

In some embodiments, the length of the rod-like particle is 30 nm or more (e.g., 35 nm or more, 40 nm or more, 45 nm or more, 50 nm or more, 55 nm or more, 60 nm or more, 65 nm or more, 70 nm or more, 75 nm or more, 80 nm or more, 85 nm or more, 90 nm or more, 95 nm or more, 100 nm or more, 110 nm or more, 120 nm or more, 130 nm or more, 140 nm or more, 150 nm or more, 160 nm or more, 170 nm or more, 180 nm or more, 190 nm or more, 200 nm or more, 210 nm or more, 220 nm or more, 230 nm or more, 240 nm or more, or 250 nm or more). In some embodiments, the length of the rod-like particle is 260 nm or less (e.g., 250 nm or less, 240 nm or less, 230 nm or less, 220 nm or less, 210 nm or less, 200 nm or less, 190 nm or less, 180 nm or less, 170 nm or less, 160 nm or less, 150 nm or less, 140 nm or less, 130 nm or less, 110 nm or less, 100 nm or less, 95 nm or less, 90 nm or less, 85 nm or less, 80 nm or less, 75 nm or less, 70 nm or less, 65 nm or less, 60 nm or less, 55 nm or less, 50 nm or less, 45 nm or less, 40 nm or less, or 35 nm or less). The length of the rod-like particle can range from any of the minimum values described above to any of the maximum values described above, for example from 30 nm to 260 nm (e.g., from 40 nm to 260 nm, from 50 nm to 260 nm, from 60 nm to 260 nm, from 70 nm to 260 nm, from 80 nm to 260 nm, from 90 nm to 260 nm, from 100 nm to 260 nm, from 110 nm to 260 nm, from 120 nm to 260 nm, from 130 nm to 260 nm, from 140 nm to 260 nm, from 150 nm to 260 nm, from 160 nm to 260 nm, from 170 nm to 260 nm, from 180 nm to 260 nm, from 185 nm to 255 nm, from 190 nm to 250 nm, from 195 nm to 245 nm, from 200 nm to 240 nm, from 205 nm to 235 nm, from 210 nm to 230 nm, or from 215 nm to 225 nm). In some embodiments, the length of the rod-like particle is 220 nm.

In some embodiments, the width of the rod-like particle is 10 nm or more (e.g., 12 nm or more, 14 nm or more, 16 nm or more, 18 nm or more, 20 nm or more, 22 nm or more, 24 nm or more, 26 nm or more, 28 nm or more, 30 nm or more, 32 nm or more, 34 nm or more, 36 nm or more, 38 nm or more, 40 nm or more, 42 nm or more, 44 nm or more, 46 nm or more, 48 nm or more, 50 nm or more, 52 nm or more, 54 nm or more, 56 nm or more, 58 nm or more, 60 nm or more, 62 nm or more, 64 nm or more, 66 nm or more, or 68 nm or more). In some embodiments, the width of the rod-like particle is 70 nm or less (e.g., 68 nm or less, 66 nm or less, 64 nm or less, 62 nm or less, 60 nm or less, 58 nm or less, 56 nm or less, 54 nm or less, 52 nm or less, 50 nm or less, 48 nm or less, 46 nm or less, 44 nm or less, 42 nm or less, 40 nm or less, 38 nm or less, 36 nm or less, 34 nm or less, 32 nm or less, 30 nm or less, 28 nm or less, 26 nm or less, 24 nm or less, 22 nm or less, 20 nm or less, 18 nm or less, 16 nm or less, 14 nm or less, or 12 nm or less). The width of the rod-like particle can range from any of the minimum values described above to any of the maximum values described above, for example from 10 nm to 70 nm (e.g., from 14 nm to 70 nm, from 18 nm to 70 nm, from 22 nm to 70 nm, from 26 nm to 70 nm, from 30 nm to 70 nm, from 32 nm to 68 nm, from 34 nm to 66 nm, from 36 nm to 64 nm, from 38 nm to 62 nm, from 40 nm to 60 nm, from 42 nm to 58 nm, from 44 nm to 56 nm, from 46 nm to 54 nm, or from 48 nm to 52 nm). In some embodiments, the width of the rod-like particle is 50 nm.

In some embodiments, the height of the rod-like particle is 10 nm or more (e.g., 12 nm or more, 14 nm or more, 16 nm or more, 18 nm or more, 20 nm or more, 22 nm or more, 24 nm or more, 26 nm or more, 28 nm or more, 30 nm or more, 32 nm or more, 34 nm or more, 36 nm or more, 38 nm or more, 40 nm or more, 42 nm or more, 44 nm or more, 46 nm or more, 48 nm or more, 50 nm or more, 52 nm or more, or 54 nm or more, 56 nm or more, or 58 nm or more). In some embodiments, the height of the rod-like particle is 60 nm or less (e.g., 58 nm or less, 56 nm or less, 54 nm or less, 52 nm or less, 50 nm or less, 48 nm or less, 46 nm or less, 44 nm or less, 42 nm or less, 40 nm or less, 38 nm or less, 36 nm or less, 34 nm or less, 32 nm or less, 30 nm or less, 28 nm or less, 26 nm or less, 24 nm or less, 22 nm or less, 20 nm or less, 18 nm or less, 16 nm or less, 14 nm or less, or 12 nm or less). The height of the rod-like particle can range from any of the minimum values described above to any of the maximum values described above, for example from 10 nm to 60 nm (e.g., from 12 nm to 60 nm, from 14 nm to 60 nm, from 16 nm to 60 nm, from 18 nm to 60 nm, from 20 nm to 60 nm, from 22 nm to 58 nm, from 24 nm to 56 nm, from 26 nm to 54 nm, from 28 nm to 52 nm, from 30 nm to 50 nm, from 32 nm to 48 nm, from 34 nm to 46 nm, from 36 nm to 44 nm, or from 38 nm to 42 nm). In some embodiments, the height of the rod-like particle is 40 nm.

In some embodiments, the rod-like particle can be defined by its aspect ratio, defined as the length of the rod-like particle divided by the width of the rod-like particle. In some examples, the rod-like particle can have an aspect ratio of 1.5 or more (e.g., 1.75 or more, 2.0 or more, 2.25 or more, 2.5 or more, 2.75 or more, 3.0 or more, 3.25 or more, 3.5 or more, 3.75 or more, 4.0 or more, 4.25 or more, 4.5 or more, 4.75 or more, 5.0 or more, 5.25 or more, 5.5 or more, 5.75 or more, 6.0 or more, 6.25 or more, 6.5 or more, 6.75 or more, 7.0 or more, 7.25 or more, 7.5 or more, 7.75 or more, 8.0 or more, 8.25 or more, 8.5 or more, 8.75 or more, 9.0 or more, 9.25 or more, 9.5, or 9.75 or more). In some embodiments, the rod-like particle can have an aspect ratio of 10.0 or less (e.g., 9.75 or less, 9.5 or less, 9.25 or less, 9.0 or less, 8.75 or less, 8.5 or less, 8.25 or less, 8.0 or less, 7.75 or less, 7.5 or less, 7.25 or less, 7.0 or less, 6.75 or less, 6.5 or less, 6.25 or less, 6.0 or less, 5.75 or less, 5.5 or less, 5.25 or less, 5.0 or less, 4.75 or less, 4.5 or less, 4.25 or less, 4.0 or less, 3.75 or less, 3.5 or less, 3.25 or less, 3.0 or less, 2.75 or less, 2.5 or less, 2.25 or less, 2.0 or less, or 1.75 or less). The rod-like particle can have an aspect ratio ranging from any of the minimum values described above to any of the maximum values described above, for example from 1.5 to 10.0 (e.g., from 1.5 to 7.5, from 2.0 to 7.0, from 2.5 to 6.5, from 3.0 to 6.0, from 3.5 to 5.5, from 4.0 to 5.0, or from 4.25 to 4.75).

The length, width, and height of the rod-like particles described above can be useful for a wavelength range of 450 nm to 1150 nm. In some embodiments, the dimensions (e.g., the length, width and/or height) of the first plasmonic particle and/or the second plasmonic particle can be 10 nm or more (e.g., 100 nm or more, 200 nm or more, 300 nm or more, 400 nm or more, 500 nm or more, 600 nm or more, 700 nm or more, 800 nm or more, or 900 nm or more,). In some embodiments, the dimensions (e.g., the length, width and/or height) of the first plasmonic particle and/or the second plasmonic particle can be 1000 nm or less (e.g., 900 nm or less, 800 nm or less, 700 nm or less, 600 nm or less, 500 nm or less, 400 nm or less, 300 nm or less, 200 nm or less, or 100 nm or less). The dimensions (e.g., the length, width and/or height) of the first plasmonic particle and/or the second plasmonic particle can range from any of the minimum values described above to any of the maximum values described above, for example from 10 nm to 1000 nm (e.g., from 100 nm to 900 nm, from 200 nm to 800 nm, from 300 nm to 700 nm, from 400 nm to 600 nm, from 10 nm to 800 nm, from 10 nm to 700 nm, from 10 nm to 600 nm, from 10 nm to 500 nm, 10 nm to 400 nm, from 10 nm to 300 nm, or from 10 nm to 200 nm).

In some embodiments, the angle is 10° or more (e.g., 15° or more, 20° or more, 25° or more, 30° or more, 35° or more, 40° or more, 45° or more, 50° or more, 55° or more, 60° or more, 65° or more, 70° or more, or 75° or more). In some embodiments, the angle is 80° or less (e.g., 75° or less, 70° or less, 65° or less, 60° or less, 55° or less, 50° or less, 45° or less, 40° or less, 35° or less, 30° or less, 25° or less, 20° or less, or 15° or less). In some embodiments the angle is from 10° to 80° (e.g., from 15° to 75°, 20° to 70°, from 25° to 65°, from 30° to 60°, from 30° to 40°, from 40° to 50°, from 50° to 60°, from 60° to 70°, from 70° to 80°, from 40° to 80°, or from 50° to 70°. In some embodiments, the angle is selected from 75°, 60°, 45°, and 30°. In some embodiments, the angle is 60°. In some embodiments, the angle is not 0° or 90°.

### Methods of Making

The devices described herein can be prepared, for example, using electron beam lithography, dip-pen lithography, nano-imprint lithography, focused ion beam milling, or using self-assembled nanoparticles. In some examples, the devices described herein can be prepared using electron beam lithography. In some examples, the devices described herein can be prepared further using reactive ion etching.

In some examples, a dielectric material can be deposited on a substrate. The substrate can comprise any substrate consistent with the methods described herein. For example, the substrate can be optically inactive and transparent at the wavelength or wavelength range of interest. The dielectric material can be deposited on the substrate using a variety of deposition methods known in the art, such as, for example, electron beam evaporation.

The pattern for the first plasmonic particle can be written using electron beam lithography. The pattern for the first plasmonic particle can then be transferred to the dielectric material, for example, using reactive ion etching. Metal can then be deposited onto the patterned dielectric material using, for example, an electron beam evaporator, followed by lift-off to form the first layer with the first plasmonic particle. Subsequent layers can be added by repeating similar steps, from dielectric material deposition to metal lift-off

The examples below are intended to further illustrate certain aspects of the methods and compounds described herein, and are not intended to limit the scope of the claims.

### EXAMPLES

The following examples are set forth below to illustrate the methods and results according to the disclosed subject matter. These examples are not intended to be inclusive of all aspects of the subject matter disclosed herein, but rather to illustrate representative methods, compositions, and results. These examples are not intended to exclude equivalents and variations of the present invention, which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, temperatures, pressures, and other reaction ranges and conditions that can be used to optimize the product purity and yield obtained from the described process. Only reasonable and routine experimentation will be required to optimize such process conditions.

### Example 1

Recent works have discussed the use of plasmonic and dielectric nanostructures to enhance weak CD effects for chiral molecule detection. Chiral metasurfaces (Hendry, E. et al. Nature Nanotech. 2010, 5, 783-787) and achiral plasmonic (Govorov, A O. J Phys Chem C. 2011, 115, 7914-7923; Govorov, A O et al. Nano Letters. 2010, 10, 1374-1382) and silicon nanospheres (Garcia-Etxarri, A and Dionne, J A. Phys Rev B. 2013, 87, 235409) have been explored in this context. The CD response of a chiral molecule can be enhanced around the resonance frequency of a plasmonic nanosphere (Govorov, A O. J Phys Chem C. 2011, 115, 7914-7923), as sketched in FIG. 1b, with a resultant CD again in the millidegree range, but now extended to the visible spectrum. While this is advantageous because long exposure to UV radiation can affect biomolecular samples, plasmonic achiral structures do not allow an unambiguous chiral assignment (Govorov, A O et al. Nano Letters. 2010, 10, 1374-1382) because the sign of the CD spectrum is sensitive to the binding orientation of the chiral molecule to the plasmonic nanoparticles enhancing its CD response. Chiral metasurfaces (Hendry, E. et al. Nature Nanotech. 2010, 5, 783-787) can allow for observing a measurable spectral shift for large chiral molecules, but the final measured spectrum is typically combined with the intrinsic CD spectrum of the metasurface, making a direct detection of molecular chirality difficult for smaller amounts of molecules or for smaller molecules. Herein, a platform for chirality detection based on plasmonic ‘twisted’ metamaterials whose near-field response has been tailored is shown to enable high-sensitivity handedness detection of single enantiomer drugs. Enhanced CD spectra of the molecules of interest were observed, reaching up to a few degrees (schematically shown in FIG. 1c), two orders of magnitude larger than previously reported CD measurements (Schreiber, Ret al. Nature Comm. 2013, 4, 2498). In addition, the approach discussed herein can be engineered to obtain a metamaterial response to detect the enhanced CD response of the molecules, isolated from the background CD spectrum of the metamaterial sample. This method can allow for the separation of the responses associated with opposite CD signs from enantiomers in a concentration of 15 zeptomoles, which is 10¹⁵ times less than what typical commercial CD spectroscopy is able to detect.

The metamaterial sample was fabricated using electron beam lithography and an etch-back planarization method on an optical flat glass substrate, as described fully by Zhao et al. and discussed briefly herein. (Zhao, Y et al. Nature Comm. 2012, 3, 870).

Gold alignment marks (100 nm thick) were fabricated on a bare glass substrate (C1737-0107, Delta Technologies), then silicon dioxide was deposited (80 nm thick with a 5% thickness variation) on the substrate using an electron beam (e-beam) evaporator. E-beam resist ZEP 520 was diluted with ZEP A (Anisole), then spun onto the substrate to obtain a thickness of 100 nm.

The plasmonic metamaterial pattern was written using a JBX-6000FS/E e-beam aligner at an accelerating voltage of 50 kV. The dimensions of the unit cell nanodipole (e.g., each nanorod) were 220 nm×50 nm×40 nm (length×width×thickness). The unit cell was embedded in a square lattice of 300 nm×300 nm. The fabricated plasmonic metamaterial sample has a foot-print of 200 μm by 200 μm, which includes more than 400,000 unit cells. After exposure, the sample was developed in ZED-N50 (Emyl Acetate). The pattern was then transferred to the silicon dioxide thin film by reactive ion etching using a gas mixture of CF4 and helium in Trion Oracle plasma etcher to etch off 55 nm of silicon dioxide. A 5 nm titanium adhesion layer and a 40 nm gold layer were sequentially deposited onto the sample using a CHA e-beam evaporator. The sample then underwent the lift-off process in N-methyl-2-pyrrolidone to complete the first layer. An 80 nm silicon dioxide layer served as a dielectric spacer, coated through e-beam evaporation. The surface was planarized after metal lift-off.

Efforts were made to ensure a flat surface after each metal nanorod deposition. To achieve this, the metal lift-off e-beam resist mask was first used to etch 55-nm-deep trenches in the substrate via reactive ion etching; a 55-nm thick metal layer was then deposited. After the lift-off process, the metal nanorods are positioned in the trenches etched in the substrate. The planarization process reduced surface-height variation from 55 nm to 5 nm. Subsequent layers were added by repeating similar steps, from silicon dioxide deposition to metal lift-off.

During the analyte quantity estimation, the imaging area was covered by a 10 nm thick layer of analyte (deposited by spin-coating), and the imaging area was confined to an area of 35 μm by 3.5 μm by controlling the slit of the imaging spectrometer. The imaging spectrometer contains a 150 g/mm grating and a nitrogen-cooled Si CCD detector (Princeton Instruments). This imaging area covered around 1361 unit cells on the metamaterial surface and contained 1.225×10⁻¹² ml of the analyte. Using the concentration of 1 mg/ml for Concanavalin A (ConA) with a molecular weight of 104 kilo-Daltons (kDa, 1 Da=1.66×10⁻²⁷ kg), it was calculated that the imaging area contained ˜7095 molecules, which corresponds to 11.8 zeptomoles of chiral molecules within that area, and approximately 5 molecules per unit cell. If filling factors of the metamaterial are taken into account (i.e., the area of the rods divided by the area of the unit cells), around 866 molecules are within the effective region of the imaging area (where the gold nanorods reside), and this value corresponds to about 1 molecule per nanorod.

Propanediol enantiomers, (S)-(+)-1,2-Propanediol and (R)-(−)-1,2-Propanediol, were used as received from Sigma-Aldrich (products 540242 and 540250, 96%). The propanediol enantiomers were prepared with a flow-cell with thickness of 70 μm. The flow cell was created using a glass cover-slip, which was affixed to the device with a spacer layer of adhesive (˜70 μm thick) on three edges. The analyte solution then filled the cell under the cover slip via capillary forces. The anticancer drug irinotecan hydrochloride (Sigma-Aldrich) was dissolved in water to form a solution with a concentration of 1 mg/ml. The anticancer drug experiment was also performed with the flow-cell. The cover-slip was removed after each measurement for cleaning the device, and a new flow cell was prepared for each new measurement. The protein Concanavalin A was dissolved in 10 mM Tris/HCl buffer solution with a controlled pH value at 7, forming a solution with a concentration of 1 mg/ml. The prepared protein solution was spin-coated onto the clean metamaterial sample at a spin speed of 2000 rpm, forming a monolayer of 10 nm, which was confirmed with ellipsometry measurements (J. J. Woollam M-2000 DI).

The metamaterial sample was used for multiple measurements. After each measurement, the sample was immersed in deionized water for 72 hours and then cleaned in base piranha solution to remove excess organic residues on the sample (3:1 mixture of ammonium hydroxide (NH₄OH) with hydrogen peroxide). This treatment also left the metamaterial hydrophilic for better adhesion, especially for the protein sample, which was prepared by spin-coating.

Full vectorial numerical simulations were conducted using commercially available software based on finite integration method (CST Microwave Studio 2011 and HFSS). The permittivity of gold followed the values from Johnson and Christy (Johnson, P B and Christy, R W. Phys Rev B. 1972, 6, 4370-4379). The permittivity of the titanium adhesive layer was simulated using values obtained from a website. The glass substrate was considered to be nondispersive silicon dioxide with a permittivity of 2.25 and negligible absorption.

The chiral molecules adsorbed on the surface of the metamaterial were modeled as a thin homogeneous chiral film with thickness w. The loaded metamaterial was excited separately with a right-handed (R) and a left-handed (L) circularly polarized plane wave. The wavenumber of the incident field is k in the molecular layer. The output from the metamaterial is composed of both left- and right-handed plane waves, which is considered as the input to the chiral film. The circular dichroism of the wave exiting the metamaterial but before entering the chiral film was defined as CDᵢ:

$${CD}_{i} = {tan}^{- 1} \frac{{I}_{R} - {I}_{L}}{{I}_{R} + {I}_{L}} = {tan}^{- 1} \frac{{\vert {T}_{LR} \vert}^{2} + {\vert {T}_{RR} \vert}^{2} - {\vert {T}_{RL} \vert}^{2} - {\vert {T}_{LL} \vert}^{2}}{{\vert {T}_{LR} \vert}^{2} + {\vert {T}_{RR} \vert}^{2} + {\vert {T}_{RL} \vert}^{2} - {\vert {T}_{LL} \vert}^{2}} \qquad ( S1 )$$

where I_{R} and I_{L} denote the total transmitted power of the plane waves with right- and left-handed excitations. The circular dichroism after the chiral film can be calculated by applying the electromagnetic boundary conditions for a chiral film of thickness w. Expanding the output circular dichroism in terms of kw and keeping only the first two leading terms provided kw<1, results in:

$${CD}_{o} = {CD}_{i} + 4 kw Im [ {κ}_{m} ] \frac{{\vert {T}_{LR} {T}_{RL} \vert}^{2} - {\vert {T}_{LL} {T}_{RR} \vert}^{2}}{{( {\vert {T}_{LR} \vert}^{2} + {\vert {T}_{RR} \vert}^{2} )}^{2} + {( {\vert {T}_{LL} \vert}^{2} + {\vert {T}_{RL} \vert}^{2} )}^{2}} \qquad ( S2 )$$

where κₘ is the chirality of the chiral molecule film. By expanding CDₒ near the resonance (k₀=2π/λ₀, with λ₀ being the resonance free-space wavelength of CDᵢ), leads to:

$${CD}_{o} \approx {CD}_{i}^{( 0 )} + \frac{{CD}_{i}^{( 2 )}}{2} {( k - {k}_{0} )}^{2} + 4 kw Im [ {κ}_{m} ] \frac{{\vert {T}_{LR} {T}_{RL} \vert}^{2} - {\vert {T}_{LL} {T}_{RR} \vert}^{2}}{{( {\vert {T}_{LR} \vert}^{2} + {\vert {T}_{RR} \vert}^{2} )}^{2} + {( {\vert {T}_{LL} \vert}^{2} + {\vert {T}_{RL} \vert}^{2} )}^{2}} \qquad ( S3 )$$

where CDᵢ⁽²⁾ represents the second derivative of CDᵢ with respect to k₀. From Equation (S3), the shift in resonance frequency of CDₒ with respect to the resonance frequency of the CDᵢ can be determined according to Equation (S4).

$$Δω = c \frac{4 Im [ {κ}_{m} ] w}{{CD}_{i}^{( 2 )}} \frac{{\vert {T}_{RR} \vert}^{2} {\vert {T}_{LL} \vert}^{2} - {\vert {T}_{LR} \vert}^{2} {\vert {T}_{RL} \vert}^{2}}{{( {\vert {T}_{LR} \vert}^{2} + {\vert {T}_{RR} \vert}^{2} )}^{2} + {( {\vert {T}_{LL} \vert}^{2} + {\vert {T}_{RL} \vert}^{2} )}^{2}} \qquad ( S4 )$$

The sign of the frequency shift can be reversed either due to a different sign of CDᵢ⁽²⁾ or a change of sign in Im[κₘ], which implies that the frequency shift will be opposite for the same chiral molecules on top of chiral metamaterials with opposite handedness, or opposite for S and R chiral molecules on top of the same metamaterial.

The equations (S2)-(S4) are obtained assuming that the chirality coefficient of the molecular layer is known, and it neglects the near-field interaction between the metamaterial inclusions and the chiral molecules. Here, the field and chiral enhancement factors are incorporated in calculating the total output circular dichroism. The following analysis is based on the assumption that the near-field interaction between molecules and electromagnetic fields emerging from the twisted metamaterial can be modeled assuming plane wave propagation in the molecular layer, and adjusting the effective permittivity and chirality of this layer as a function of the enhanced local density of states near the metamaterial surface. This adjustment is based on a comparison between near- and far-field effects of the twisted metamaterial. The imaginary parts of permittivity and chirality are respectively scaled according to the field and chiral enhancement factors in the near-field. This scaling can be justified by noting that the power loss density in the chiral molecular layer can be separated into two parts. The first part arises from the loss embedded in the permittivity of the molecules, which is proportional to the product of the imaginary part of permittivity and the intensity of the field (Im[ε]|E|²). The second part originates from the chiral nature of the molecular layer, which is proportional to the product of the imaginary part of chirality of the molecules and the chirality of the field (Im[κₘ]Im[E·H*]) (Lindell, IV et al. Electromagnetic Waves in Chiral and Bi-Isotropic Media. Artech House, London, 1994).

The near-field enhancement factor F is defined as the near-field intensity within the vicinity of the metamaterial surface normalized to the far-field intensity,

$$F = \frac{{\vert {E}_{Near \text{-} Fitted} \vert}^{2}}{{\vert {E}_{Far \text{-} Field} \vert}^{2}} \qquad ( S5 )$$

The amount of loss due to the imaginary part of the permittivity for a molecular layer placed in the near-field of the twisted metamaterial can be expressed as F Im[ε]|E|², where the electric field is a far-field quantity. It is seen that the amount of loss can converge to the same value by either keeping the field enhancement factor inside |E|² or embedding this enhancement factor inside the imaginary part of the permittivity while keeping |E|² unchanged as a far-field plane wave, introducing an effective permittivity that accounts for the near-field enhancement. Similarly for the losses due to the imaginary part of chirality, one can define the chiral enhancement factor as K. Here K is defined as the maximum chirality at the near-field of the metamaterial normalized to the maximum of the far-field chirality, where the field chirality is defined as C=Im[E·H*] (Tang, Y Q and Cohen, A E. Science. 2011, 332, 333-336; Tang, Y Q and Cohen, A E. Phys Rev Lett. 2010, 104, 163901).

$$K = \frac{{Im [ E \cdot {H}^{*} ]}_{Near \text{-} Fitted}}{{Im [ E \cdot {H}^{*} ]}_{Far \text{-} Fitted}} \qquad ( S6 )$$

Again, the loss can be expressed as the effect of the actual near-field chirality C interacting with Im[κₘ], or equivalently it can be stated that the loss is due to the interaction between far-field plane waves with a material with effective chirality coefficient K Im[κₘ].

The coefficient κₘ is associated with the intrinsic CD response of the chiral molecules, but its effective value can be largely boosted by the near-field interaction with the plasmonic particles forming the metamaterial. The complex refractive index of the chiral molecules can be written as:

n_{LCP}=\sqrt{ε_{L}}+κ_{mL}=a+ib_{L}−(c+id_{L})

n_{RCP}=\sqrt{ε_{R}}+κ_{mR}=a+ib_{R}+(c+id_{R}) (S7)

where the subscript denotes the polarization of the plane waves propagating in the chiral film. In the above equation, the parameters a, b, c and d are purely real numbers, associated with the real and imaginary parts of effective permittivity and chirality. As discussed above, here the near-field effects manifest themselves in the imaginary parts of effective permittivity and chirality of the film and therefore, the real parts of these two quantities are assumed to be equal for both right and left-handed impinging waves.

In conventional CD measurements, for which the chiral molecules interact with the impinging circularly polarized light without any contribution from the substrate, the refractive index of the chiral molecular film experienced by light is only different by the sign of κₘ; in other words, since there are no enhancement factors involved (F=1, κ=1), b_{L}=d_{R} and d_{L} =d_{R} in Equation (S7). For CD measurements with chiral molecules adsorbed on achiral plasmonic structures, the near-field enhancement factor F leads to b_{L}≠b_{R}, but the lack of a chirality enhancement factor (κ=1) results in d_{R}. F is embedded in the imaginary terms of the relative permittivity and thus can affect the absorption for circularly polarized light by the chiral molecules, such that b_{L}=b·F_{L} and b_{R}=b·F_{R}. Notice that the field enhancement factor differs for different handedness of the circularly polarized light due to their different interactions with the chiral molecules. In addition to F, plasmonic chiral metamaterials introduce an additional chiral enhancement factor κ (Schaferling, Metal. Phys Rev X. 2012, 2, 031010; Meinzer, Net al. Phys Rev B. 2013, 88, 041407(R)), resulting in b_{L}≠b_{R} and d_{L}≠d_{R}, where d_{R}=d·K_{R}, d_{L}=d·K_{L}, respectively.

Since one particular polarization can be selectively enhanced to a larger degree in the near field, its effective losses inside the chiral film will also be larger compared to the other polarization. Therefore, CDₒ can be revised by embedding these enhancement terms as

$${CD}_{o} = {CD}_{i} + - kw Re [ \sqrt{{ɛ}_{r}} ] Im [ \sqrt{{ɛ}_{r}} ] ( {Σ}_{R} - {Σ}_{L} ) \frac{( {\vert {T}_{LR} \vert}^{2} + {\vert {T}_{RR} \vert}^{2} ) ( {\vert {T}_{LL} \vert}^{2} + {\vert {T}_{RL} \vert}^{2} )}{{( {\vert {T}_{LR} \vert}^{2} + {\vert {T}_{RR} \vert}^{2} )}^{2} + {( {\vert {T}_{LL} \vert}^{2} + {\vert {T}_{RL} \vert}^{2} )}^{2}} + kw ( Im [ \sqrt{{ɛ}_{r}} ] {Δ}_{R} + 2 Im [ {κ}_{m} ] {K}_{R} ) \frac{( {\vert {T}_{LR} \vert}^{2} - {\vert {T}_{RR} \vert}^{2} ) ( {\vert {T}_{RL} \vert}^{2} + {\vert {T}_{LL} \vert}^{2} )}{{( {\vert {T}_{LR} \vert}^{2} + {\vert {T}_{RR} \vert}^{2} )}^{2} + {( {\vert {T}_{LL} \vert}^{2} + {\vert {T}_{RL} \vert}^{2} )}^{2}} + kw ( Im [ \sqrt{{ɛ}_{r}} ] {Δ}_{L} + 2 Im [ {κ}_{m} ] {K}_{L} ) \frac{( {\vert {T}_{LR} \vert}^{2} + {\vert {T}_{RR} \vert}^{2} ) ( {\vert {T}_{RL} \vert}^{2} - {\vert {T}_{LL} \vert}^{2} )}{{( {\vert {T}_{LR} \vert}^{2} + {\vert {T}_{RR} \vert}^{2} )}^{2} + {( {\vert {T}_{LL} \vert}^{2} + {\vert {T}_{RL} \vert}^{2} )}^{2}} \qquad ( S8 )$$

where

Σ_{R}=F_{RR}+F_{LR} ΣE_{L}=F_{RL}+F_{LL}

Δ_{R}=F_{RR}−F_{LR} Δ_{L}=F_{RL}−F_{LL} (S9)

F_{LR} denotes the enhancement in the intensity of left-handed electric field near the surface of the metamaterial for a right-handed impinging wave. A similar convention is used for the other enhancement factors, as well as for the transmission coefficients. K_{R} and K_{L} are chiral enhancement factors for right and left-handed incident waves, respectively. To cancel the effective losses in CDₒ, both right handed (+) and left handed (−) metamaterials were employed. By taking advantages from symmetries, such as CDᵢ⁺=−CDᵢ⁻, T_{RR}⁺=T_{LL}⁻, T_{LR} ⁺T_{RL}⁻, T_{RL}⁺=T_{LR}⁻, T_{LL}⁺=T_{RR}⁻, Σ_{R}⁺=Σ_{L}⁻, Σ_{L}⁺=Σ_{R}⁻, Δ_{R}⁺=−Δ_{L}⁻, Δ_{L}⁻=−Δ_{R}⁻, where the superscript represents the corresponding handedness of the metamaterial, one can obtain

$$\frac{{CD}_{o}^{+} + {CD}_{o}^{-}}{4 kw Im [ {κ}_{m} ]} P = {K}_{R}^{+} ( {\vert {T}_{RL}^{+} \vert}^{2} + {\vert {T}_{LL}^{+} \vert}^{2} ) ( {\vert {T}_{LR}^{+} \vert}^{2} - {\vert {T}_{RR}^{+} \vert}^{2} ) + {K}_{L}^{+} ( {\vert {T}_{RL}^{+} \vert}^{2} - {\vert {T}_{LL}^{+} \vert}^{2} ) ( {\vert {T}_{LR}^{+} \vert}^{2} + {\vert {T}_{RR}^{+} \vert}^{2} ) \qquad ( S10 )$$

where

P=(|T_{LR}|²+|T_{RR}⁺|²)²+(|T_{LL}⁺|²+|T_{RL}⁺|²)² (S11)

which is equation (4) below. Note that the effects from the field enhancement and losses from the permittivity are cancelled out in this manipulation and the remaining terms are only dependent on the imaginary part of Km and the chiral enhancement factors.

It is worth noting that even with fabrication imperfections when CDᵢ⁺ doesn't completely cancel out CDᵢ⁻ from the metamaterials. Equation (S10) can be modified to:

$$\frac{( {CD}_{o}^{+} - {CD}_{i}^{+} ) + ( {CD}_{o}^{-} - {CD}_{i}^{-} )}{4 kw Im [ {κ}_{m} ]} P = {K}_{R}^{+} ( {\vert {T}_{RL}^{+} \vert}^{2} + {\vert {T}_{LL}^{+} \vert}^{2} ) ( {\vert {T}_{LR}^{+} \vert}^{2} - {\vert {T}_{RR}^{+} \vert}^{2} ) + {K}_{L}^{+} ( {\vert {T}_{RL}^{+} \vert}^{2} - {\vert {T}_{LL}^{+} \vert}^{2} ) ( {\vert {T}_{LR}^{+} \vert}^{2} + {\vert {T}_{RR}^{+} \vert}^{2} )$$

where the subtraction of the CDᵢ removes the system errors that come from fabrication imperfections, leaving the summation still directly related to the signs of the molecular chirality.

The CD response of a sample is the difference in transmitted power between right- and left-handed circularly polarized light, normalized to the total transmitted power for the two excitations:

$$CD = {tan}^{- 1} ( \frac{{I}_{RCP} - {I}_{LCP}}{{I}_{RCP} + {I}_{LCP}} ) \qquad ( 1 )$$

where I represents the total intensity transmitted through the system, and the subscripts indicate the excitation (right- and left-circular) polarizations.

The induced CD response, CDₒ, of a metamaterial sample loaded with a uniform layer of chiral molecules adsorbed on its surface can be written in closed form as

$${CD}_{o} = {CD}_{i} + 4 kw Im [ {κ}_{m} ] \frac{{\vert {T}_{LR} {T}_{RL} \vert}^{2} - {\vert {T}_{LL} {T}_{RR} \vert}^{2}}{{( {\vert {T}_{LL} \vert}^{2} + {\vert {T}_{RL} \vert}^{2} )}^{2} + {( {\vert {T}_{RR} \vert}^{2} + {\vert {T}_{LR} \vert}^{2} )}^{2}} \qquad ( 2 )$$

where CDᵢ denotes the inherent CD of the metamaterial without molecules; T_{LR} is the left-handed circularly polarized field transmitted through the metamaterial layer with a right-handed circularly polarized input, and similarly for the other Tᵢⱼ coefficients; κₘ describes the effective chirality coefficient of the molecular layer, k=2π/λ is the wave vector with λ being the wavelength inside the molecular layer, and w is its thickness, for which it can be assumed that kw <1.

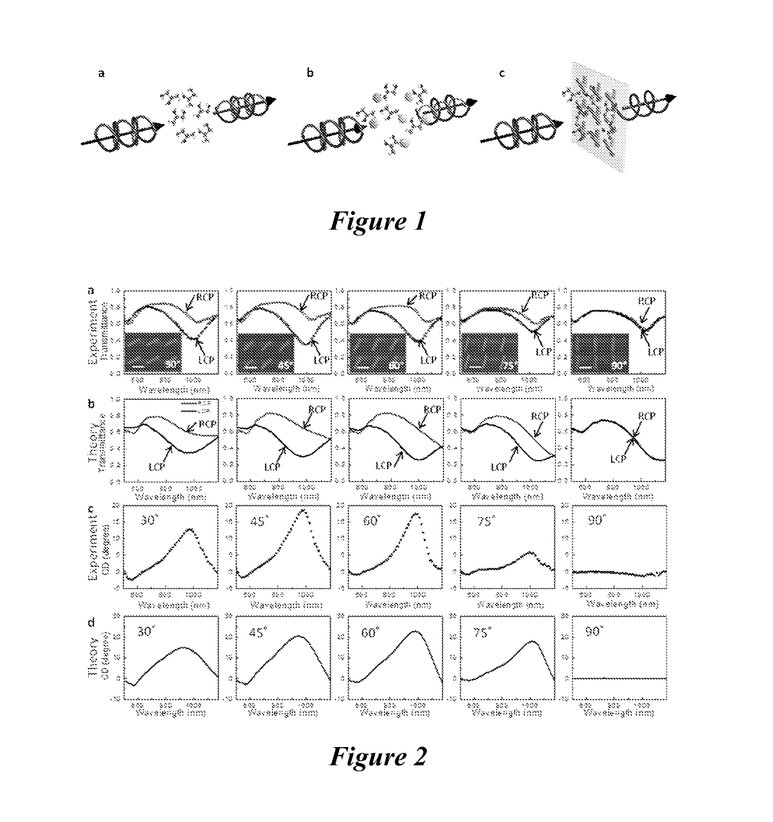

The CD output of the loaded metamaterial can be controlled by two relevant terms: the intrinsic CD response of the metamaterial and the imaginary part of the chirality coefficient κₘ. Both terms can be enhanced using twisted metamaterials (Zhao, Y et al. Nature Comm. 2012, 3, 870), formed by stacking two or more closely spaced achiral metasurfaces with a sequential rotation between neighboring layers. Twisted metamaterials can have a planarized geometry over which it is easy to deposit molecules with controllable density. Further, they can be composed of simple achiral inclusions (for example, gold nanorods) that can boost the local light-molecule interaction. Yet these twisted metamaterials can retain a chiral response associated with their lattice geometry. To demonstrate these properties, several twisted metamaterials were constructed from two stacked metasurfaces separated by an 80 nm dielectric layer with densely packed nanorod inclusions and five different twisting angles from one metasurface to the second (see inset in FIG. 1c), spanning from ±30° to ±90° at an interval of ±15°. The measured transmission spectra for positive angles are shown in FIG. 2a, with insets showing the top view scanning electron microscope (SEM) images of the corresponding metamaterials; these results are confirmed with full-wave numerical simulations in FIG. 2b. The first four samples produce a different response for different circularly polarized inputs, reflected in the CDᵢ spectra calculated using Equation (2) and shown in FIG. 2c (experiment) and FIG. 2d (simulations). By changing the relative twist angle between the two layers, both the peak wavelength and maximum value of CD, may be readily tuned and optimized (FIG. 2d).

The designed twisted metamaterial geometry retains another property that can allow the chirality detection of the adsorbed molecules to be maximized. This is associated with the enhancement of the coefficient κₘ in Equation (2). Although, κₘ is related to the intrinsic CD response of the chiral molecules, its effective value in Equation (2) can be largely enhanced by suitably engineered near-field light-matter interaction sustained by the plasmonic particles forming the metamaterial. As discussed above in more detail, the effective molecular chirality κₘ can be boosted via two mechanisms: first, by relying on the near-field enhancement factor F associated with a larger local density of states supported by achiral plasmonic effects. This is consistent with the phenomenon schematically sketched in FIG. 1b and considered in recent papers (Govorov, A O. J Phys Chem C. 2011, 115, 7914-7923; Govorov, A O et al. Nano Letters. 2010, 10, 1374-1382). Second, the effective molecular chirality κₘ can be enhanced by the chiral enhancement factor κ (Schaferling, M et al. Phys Rev X. 2012, 2, 031010; Meinzer, N et al. Phys Rev B. 2013, 88, 041407(R)), which can be defined as the maximum field chirality on the metamaterial surface normalized to the far-field chirality, where the field chirality can be defined as C=Im[E·H] (Tang, Y Q and Cohen, A E. Science. 2011, 332, 333-336; Tang, Y Q and Cohen, A E. Phys Rev Lett. 2010, 104, 163901). This second enhancement factor κ can be largely boosted by twisted metamaterials, and exploited for molecular chirality detection.

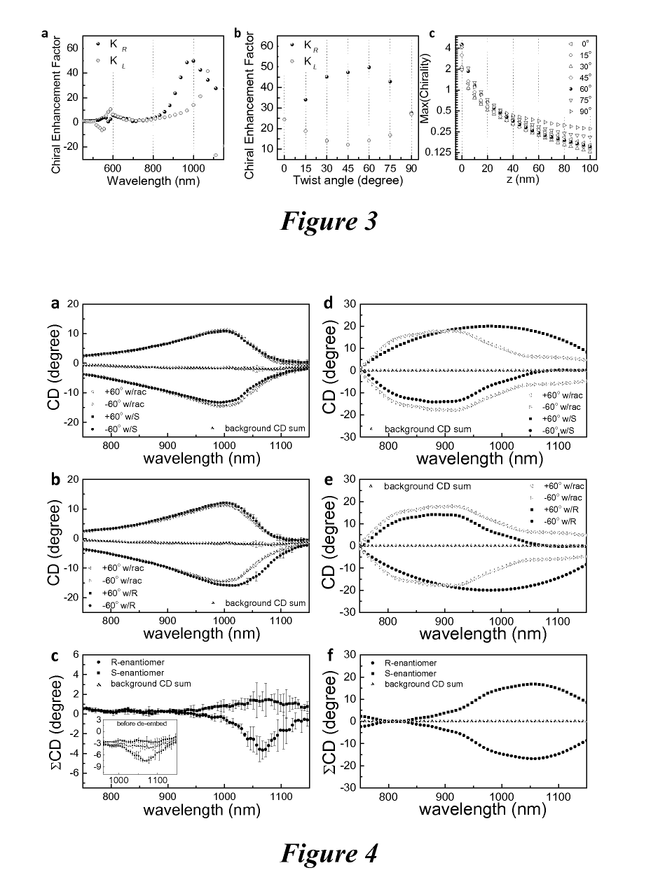

FIG. 3 shows the chiral enhancement factors, emphasizing their evolution as a function of the twist angle. FIG. 3a shows the chiral enhancement factor for +60° metamaterials over the entire wavelength of operation. The maximum enhancement occurs near the resonance of the metamaterials (≈1000 nm), especially for right-handed circularly polarized excitation, which matches the fact that right-handed waves are preferentially transmitted through positive rotated metamaterials. It is seen from FIG. 3b that with right-handed circularly polarized excitation, the +60° twist angle is the optimized angle to achieve the maximum chiral enhancement factor. FIG. 3c shows the maximum chirality away from the surface of the metamaterial, also extracted at the wavelength of 1000 nm as in FIG. 3b, which indicates the enhancement occurs at the near field and decays exponentially as it pulls away from the surface.

FIG. 2c and FIG. 3 confirm that the 60° twisted metamaterial simultaneously provides the largest CDᵢ and the largest chirality enhancement factor κ, an exemplary combination to boost chirality detection in molecules. Enhanced chirality is a near-field effect, mostly boosting the molecules positioned very close to the metamaterial surface, and therefore can sense monolayers of molecules. This is confirmed in FIG. 3c, in which the maximum simulated chirality was extracted and plotted as a function of the distance from the metamaterial surface for all considered metamaterial geometries.

The sensing features of the metamaterial platform discussed herein were further investigated using a set of well-studied enantiomers. Enantiomers with different handedness (S)-(+)-1,2-Propanediol and (R)-(−)-1,2-Propanediol were both tested on a pair of twisted metamaterials with +60° (solid curves, FIGS. 4) and −60° rotation (dotted curves, FIG. 4) separately, and the corresponding CD spectra are shown in FIG. 4a for S enantiomer, and FIG. 4b for R enantiomer.

The local interaction between metamaterial and molecules can induce a small frequency shift in the observed CD maximum, which can be analytically derived from Equation (2) by expanding CDₒ around the frequency for which ∂CDᵢ/∂ω=0:

$$Δω = c \frac{4 Im [ {κ}_{m} ] w}{{CD}_{i}^{( 2 )}} \frac{{\vert {T}_{RR} \vert}^{2} {\vert {T}_{LL} \vert}^{2} - {\vert {T}_{LR} \vert}^{2} {\vert {T}_{RL} \vert}^{2}}{{( {\vert {T}_{LR} \vert}^{2} + {\vert {T}_{RR} \vert}^{2} )}^{2} + {( {\vert {T}_{LL} \vert}^{2} + {\vert {T}_{RL} \vert}^{2} )}^{2}} \qquad ( 3 )$$

Equation (3) indicates that a change in handedness of the chiral molecule can induce an opposite frequency shift Δω, associated with opposite IM[κₘ], which changes sign for S and R enantiomers. The magnitude of this shift can be different for left-handed and right-handed excitations, due to the different chirality enhancement factors, yet the sign of frequency shift becomes a direct indication of the molecule chirality. This is observed in FIG. 4a and FIG. 4b, and in the corresponding numerical simulations in FIG. 4d and FIG. 4e.

This observed frequency shift is still a small quantity (typically around 5 nm), and it can be easily overlooked since it rides on top of the large intrinsic CD response of the metamaterial. To remove this large background signal, the CD signals from +and −60° metamaterials for each enantiomer were summed This additional step is feasible because CDᵢ(+60°)=−CDᵢ(−60°) for twisted metamaterials without analytes, and therefore their sum cancels out the common CD effect of the metamaterial on its own. What is left after post-processing is the isolated enhanced CD response associated with the near-field interaction between the metamaterial and the molecules. Analytically, this quantity can be written as:

$$\frac{\sum {CD}_{o}}{4 kw Im [ {κ}_{m} ]} P = {K}_{R}^{+} ( {\vert {T}_{RL}^{+} \vert}^{2} + {\vert {T}_{LL}^{+} \vert}^{2} ) ( {\vert {T}_{LR}^{+} \vert}^{2} - {\vert {T}_{RR}^{+} \vert}^{2} ) + {K}_{L}^{+} ( {\vert {T}_{RL}^{+} \vert}^{2} - {\vert {T}_{LL}^{+} \vert}^{2} ) ( {\vert {T}_{LR}^{+} \vert}^{2} + {\vert {T}_{RR}^{+} \vert}^{2} ) \qquad ( 4 )$$

where P=(|T_{LR}⁺|²+|T_{RR}⁺|²)²+(|T_{LL}⁺|²+|T_{RL}⁻|²)². The plus apex indicates the coefficient associated with the +60° metamaterial, and the analogous one for the −60° metamaterial may be derived from symmetry considerations: T_{RR}⁺=T_{LL}⁻, T_{LR}⁺=T_{RL}⁻, K_{R}⁺=K_{L}⁻. After processing, the effects from near-field enhancement associated with the achiral enhancement factor F can be cancelled out. Thus, the near-field chirality enhancement factor κ is the coefficient that can play a role in detecting chiral enantiomers in the proposed scheme. This is indeed the coefficient that the twisted metamaterial geometry can maximize at its output interface (FIG. 3b). Equation (4) also shows that the figure of merit ΣCDₒ displays opposite signs for S and R enantiomers, allowing unambiguous detection of the molecular chirality. This is experimentally verified in FIG. 4c, and correspondingly shown numerically in FIG. 4f.

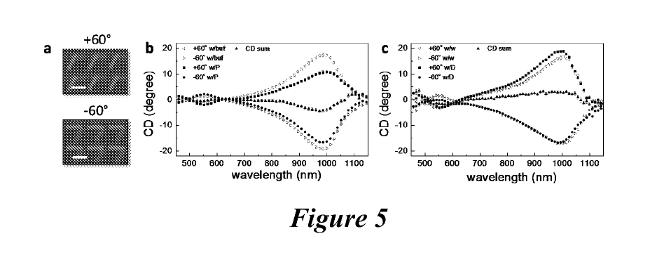

The chirality enhancement factor is a near-field effect, and it therefore can be sensitive to very thin molecular layers close to the metamaterial surface. Therefore, a monolayer of a protein sample (Concanavalin A) was tested at a concentration of 1 mg/ml dissolved in a buffer solution. The protein was spun coated on the metamaterials, covering a monolayer thickness of 10 nm (confirmed through ellipsometry measurements). FIG. 5b shows the negative bending in the measured ΣCDₒ, indicating the protein's right-handedness (Richardson, J S. PNAS USA. 1976, 73, 2619-2623). Although much smaller amounts of analytes were used in this experiment (compared to the experiment in FIG. 4, using a flow-cell preparation), the results in FIG. 5b show a much cleaner spectrum, which can be attributed to the larger intrinsic molecular chirality of Concanavalin A. Further verification of the chiral assignment of analytes was conducted on a single enantiomer anticancer drug, Irinotecan Hydrochloride, ((S)-4,11-diethyl-3,4,12,14-tetrahydro-4-hydroxy-3,14-dioxo-1H-pyrano[3′,4′:6,7]indolizino[1,2-b]quinolin-9-ylester, Sigma Aldrich), which is commonly used to treat colorectal cancer or metastatic cancers that chemotherapy has failed to treat. The resultant ΣCDₒ shows a positive bend, indicating its left-handed nature (FIG. 5c). These results imply that the methods described herein are robust, in that the methods work for molecules with different molecular weights and for solutions of varying concentration, while maintaining sensitivity to the handedness of the chiral molecules. Further, the enhanced chiral assignment can be a near field effect, suggesting that a monolayer of analytes can be used.

The results discussed herein show that, by employing the optical properties of twisted metamaterials, such twisted metamaterials can be used as a platform for the detection of molecular chirality. Enhanced sensitivity to molecular chirality, enough to detect as low as 11.8 zeptomoles of molecules in the imaging area, which corresponds to around 5 molecules per unit cell of metamaterial, was shown. The platform can, for example, be integrated with recently developed microfluidic systems (Soltani, M et al. Nature Nanotech. 2014, 9, 448-452), allowing for attograms of analytes per measurement to be detected, and the level of chirality of very small molecular samples, up to a few molecules, can be to separated and detected in real-time. In addition, the experiments discussed herein demonstrated that the use of twisted metamaterials with opposite rotation allows the intrinsic CD response from the metamaterial to be suppressed, and allows the molecular chiral response to reveal its chiral assignment. Finally, the measurements discussed herein take a fraction of a second, orders of magnitude faster than currently available commercial setups for CD measurements, which can be ideal for sequential microfluidic measurements.

The compounds and methods of the appended claims are not limited in scope by the specific compounds and methods described herein, which are intended as illustrations of a few aspects of the claims and any compounds and methods that are functionally equivalent are within the scope of this disclosure. Various modifications of the compounds and methods in addition to those shown and described herein are intended to fall within the scope of the appended claims. Further, while only certain representative compounds, methods, and aspects of these compounds and methods are specifically described, other compounds and methods and combinations of various features of the compounds and methods are intended to fall within the scope of the appended claims, even if not specifically recited. Thus a combination of steps, elements, components, or constituents can be explicitly mentioned herein; however, all other combinations of steps, elements, components, and constituents are included, even though not explicitly stated.

1. A method, comprising:
contacting a device with a sample, wherein the sample comprises an analyte;
wherein the device comprises:
a first layer comprising a first plasmonic particle having a first longitudinal axis and a first transverse axis,
a second layer comprising a second plasmonic particle having a second longitudinal axis and a second transverse axis,
wherein the first layer is located proximate to the second layer; and
wherein the second longitudinal axis is rotated at an angle compared to the first longitudinal axis.
applying a circularly polarized electromagnetic signal to the sample, the device, or a combination thereof;
capturing an electromagnetic signal from the sample, the device, or a combination thereof; and
processing the electromagnetic signal to determine a property of the sample.

2. The method of claim 1, wherein the first layer and second layer are separated by a distance of less than 800 nm.

3. (canceled)

4. The method of claim 1, wherein the circularly polarized electromagnetic signal passes through both the sample and the device before being captured.

5. The method of claim 1, wherein the device further comprises a third layer, wherein the third layer is located between the first layer and the second layer.

6. (canceled)

7. The method of claim 5, wherein the third layer comprises a dielectric material.

8. (canceled)

9. (canceled)

10. The method of claim 1, wherein the first plasmonic particle, the second plasmonic particle, or a combination thereof comprises a gold particle, a silver particle, a copper particle, an aluminum particle, or a combination thereof.

11. The method of claim 1, wherein the first plasmonic particle and/or the second plasmonic particle comprise(s) a gold particle.

12. The method of claim 1, wherein the first plasmonic particle and/or the second plasmonic particle comprise(s) a rod-like particle, wherein the rod-like particle has a length, a width and a height, wherein the length of the rod-like particle is along the first longitudinal axis and/or the second longitudinal axis, and the width is along the first transverse axis and/or the second transverse axis.

13. The method of claim 12, wherein the length of the rod-like particle is from 200 nm to 250 nm.

14. (canceled)

15. The method of claim 12, wherein the width of the rod-like particle is from 40 nm to 60 nm.

16. (canceled)

17. The method of claim 12, wherein the height of the rod-like particle is from 30 nm to 50 nm.

18. (canceled)

19. The method of claim 1, wherein the angle is from 10° to 80°.

20. The method of claim 1, wherein the angle is 75°, 60°, 45°, or 30°.

21. (canceled)

22. The method of claim 1, wherein the analyte comprises a chiral molecule.

23. The method of claim 1, wherein the analyte comprises a biomolecule, a macromolecule, a virus, a drug, or a combination thereof.

24. (canceled)

25. The method of claim 1, wherein the analyte comprises Concanavalin A, (S)-(+)-1,2-Propanediol, (R)-(−)-1,2,-Propanediol, irinotecan hydrochloride, or a combination thereof.

26. The method of claim 1, wherein contacting the device with the sample comprises depositing a layer of the sample on the device.

27. (canceled)

28. (canceled)

29. The method of claim 26, wherein the layer of the sample comprises a monolayer of the sample.

30. The method of claim 1, wherein the sample comprises 15 micromoles or less of the analyte.

31. (canceled)

32. The method of claim 1, wherein the property comprises the chirality of the analyte, the presence of chiral analyte, the circular dichroism of sample, the concentration of the analyte in the sample, or a combination thereof.
